(19) United States
(12) Patent Application Publication
(10) Pub. No.: US 2017/0146093 A1
(43) Pub. Date: May 25, 2017

(54) V-Ribbed Belt Comprising a Reinforced Coating

(71) Applicant: ContiTech Antriebssysteme GmbH, Hannover (DE)

(72) Inventors: Henning Kanzow, Wedemark (DE); Christian Greiner, Hannover (DE); Marko Schleicher, Hannover (DE); Tim Fiss, Hannover (DE)

(73) Assignee: ContiTech Antriebssysteme GmbH, Hannover (DE)

(21) Appl. No.: 15/320,329

(22) PCT Filed: May 11, 2015
(86) PCT No.: PCT/EP2015/060293

§ 371 Date: Dec. 20, 2016

(30) Foreign Application Priority Data
Jul. 8, 2014 (DE) 10 2014 213 237.1

(51) Int. Cl. F16G 5/20; F16G 5/08

(52) U.S. Cl. CPC F16G 5/20; F16G 5/08

(57) ABSTRACT

Disclosed is a V-ribbed belt comprising a profiled driving side that has a PK profile and is designed to transmit force to mating pulleys, and a substantially smooth rear side opposite the driving side; the coating of the V-ribbed belt has a thickness of more than 1.5 mm, and the elastomer mixtures of the base (1) and the coating (2) contain EPM and/or EPDM and the coating is essentially formed without fibres.

The invention relates to a V-ribbed belt composed of elastomer material, having a profiled drive side which is designed for the transmission of force to complementarily shaped belt pulleys and having a rear side which is situated opposite the drive side and which is substantially smooth, wherein the belt has, proceeding from the profiled drive side, a substructure with a ribbed profile, a layer of embedded tensile members, and a top layer.

Force-transmitting V-ribbed belts are produced in a variety of types of construction and are known in a multiplicity of embodiments. With regard to their major embodiments and dimensions, V-ribbed belts are standardized inter alia in DIN 7867. V-ribbed belts with the profiles PJ, PK, PL and PM are used in general mechanical engineering, and the profile PH is preferably used in the household appliance sector. For the drive of auxiliary assemblies of motor vehicle engines, use is made almost exclusively of V-ribbed belts with PK profiles, which are distinguished by a flank angle of approximately 40° (in practice 40+/−3°) and a pitch of approximately 3.56 mm (in practice 3.56+/−0.05 mm).

In numerous applications, not only are assemblies driven by way of the drive side of the drive belt, which assemblies have correspondingly shaped belt pulleys on their drive shaft, but assemblies are also driven, with the aid of so-called back rollers, by way of the correspondingly diverted belt rear side which acts on smooth belt pulleys. This is for example often the case with a V-ribbed belt drive in a motor vehicle engine, wherein the drive of the water pump as an auxiliary assembly may be realized by way of the smooth belt rear side. Tensioning rollers are often also in the form of back rollers.

V-ribbed belt drives in motor vehicles can be designed for a long service life; nowadays, a service life of more than 240,000 km can often be realized. One of the reasons for these long service lives lies in the use of rubber mixtures based on thermally durable, synthetic rubbers such as ethylene propylene diene copolymer (EPDM) and ethylene propylene copolymer (EPM). Furthermore, the service life has been considerably increased through the reduction of the V-ribbed belt thickness from previously approximately 6 mm to values between 4 and 5 mm. By contrast to V belts which are often placed under static tension, V-ribbed belts are generally tensioned by way of an automatic tensioning system in order to ensure an as far as possible constant belt force under all operating conditions.

In the case of vehicles with V-ribbed belts being used in rough, rocky areas or regions without paved roads, problems may arise if, during travel, small stones with diameters of 2-5 mm are thrown up and passed into the belt drive. Such stones can become stuck both between the belt ribs and in the pulley grooves. The stones in grooves or pulleys generate extremely high amounts of wear on the belt, change the running and slippage characteristics to a very great extent, and can damage the belt of a belt drive as it revolves.

A V-ribbed belt may be severely affected for example as a result of belt splitting and cord uncoiling. Cord uncoiling is to be understood to mean the emergence of cords from the belt assembly, often starting at a cut edge of the one or more cords. This results inter alia from a conventional production method for V-ribbed belts, in the case of which a torus (“unprocessed loop”) is built up as a “multiple belt” on a drum and is later cut into individual rings, that is to say into individual belts. The cord layers that are coiled during said production process must necessarily be severed during the cutting process, and may under the stated circumstances constitute vulnerable points for damage.

The problem of stones/foreign bodies penetrating into belt ribs and pulley grooves can self-evidently be best solved by way of a shield or encapsulation of the belt drive using covers or protective caps. However, many automobile manufacturers, who are subject to price pressures, seek to save the costs associated therewith. A fast belt change is also no longer possible if comprehensive covers have to be removed beforehand.

JP H0882346 A discloses a V-ribbed belt having a V-shaped profile, which belt has an outer layer, composed of multiple layers, on the belt rear side, wherein a rear-side fabric has reinforcement filaments, which are laid during the application process, wound around it. In this way, it is sought to prevent longitudinal cracks and a lateral fold-over of belts. It is however disadvantageously the case that the rear-side fabric also takes in sand or small stones, such that back rollers that are provided become worn very quickly during operation.

JP H07238993 A has disclosed a double V-belt in which the layer comprising the coiled tensile members is reinforced on each side by transversely laid monofilaments between tensile carrier layer and V-shaped profile of the ribs, which. In this way, too, it is sought to prevent splitting or longitudinal cracks. The production of this construction is however disadvantageously highly cumbersome.

It was thus the object of the invention to provide a V-ribbed belt which is usable without encapsulation even under rough conditions and which has a long service life without belt splitting and cord uncoiling.

This object is achieved by the features of the main claim. Further advantageous configurations are disclosed in the subclaims.

Surprisingly, and in complete contrast to the conventional teaching, this is realized, in the case of the solution according to the invention, through the use of a relatively thick top layer, specifically by virtue of the fact that the top layer of the V-ribbed belt with a PK profile has a thickness of more than 1.5 mm, wherein the top layer is formed substantially without fibers. The rubber mixtures are in this case based on EPDM, EPM or EPDM/EPM mixtures.

The combination of these design elements in the construction of the V-ribbed belt lead to considerably lengthened service lives in the presence of the abovementioned loading imparted by small stones in rough, rocky areas or regions without paved roads.

The contrast with respect to the conventional teaching arises in particular from the fact that, until now, it has been sought to as far as possible avoid relatively large thicknesses of top layers in V-ribbed belts, because such belts generate relatively high bending stresses and heat up to a much greater extent during operation in the presence of a continuously fluctuating bending stress, such that the service life is reduced. In the case of the solution according to the invention, in which the top layer thickness is combined in particular with the use of fiber-free top layers, it is however the case that even unusually thick top layers scarcely lead to significant degradation of service life.

An advantageous refinement which is effective in this sense consists in that the profile depth is as shallow as possible, and amounts to at most 2.1 mm.

An advantageous refinement consists in that the thickness of the top layer amounts to at most 3 mm. This yields a balanced compromise between heating of the belt and resistance to belt splitting and cord uncoiling.

Identical advantages which additionally also take into consideration the requirement for inexpensive production are achieved in the case of a further advantageous embodiment which consists in that the top layer is formed with a thickness of 1.8 to 3 mm, preferably with a thickness of 2.0 to 2.5 mm.

A further advantageous embodiment consists in that the profile depth amounts to 1.5 to 1.9 mm. The smaller the profile depth, the less likely it is that small stones will become stuck between the ribs and damage the pulleys during operation. This is self-evidently possible only up to certain limits, because excessively small profile depths lead to a reduction in transmission power. The advantageous embodiment claimed here makes allowance for this conflict of aims and permits the best possible configuration of the belt.

A further advantageous embodiment consists in that the V-ribbed belt has, in the region of the embedded tensile members, that is to say between the tensile members and in the region slightly above and/or slightly below the cords, a thin fiber-containing embedding mixture which is formed so as to be at most 1 mm thick, preferably formed with a thickness of less than 0.6 mm. Such an embedding mixture enhances the connection between tensile members/cords and surrounding elastomer matrix, that is to say intensifies the adhesion of the cords and furthermore has the effect that cord uncoiling/tensile strength uncoiling is prevented.

The stated advantages are assisted by a further embodiment which consists in that the fibers of the embedding mixture are oriented substantially in the belt circumferential direction.

It is the intention for the entire top layer to comprise no fibers, wherein this applies in particular to the outer region which is situated furthest remote from the cord, because the use of fiber mixtures leads to an increase of the inherent heating of the belt during operation, which significantly shortens the service life of the belt.

A further advantageous embodiment consists in that the fibers of the embedding mixture comprise aramid or PVA fibers or a mixture of such fibers. Said fiber types are highly temperature-resistant, increase the adhesion of the cords in the material, and can be processed extremely well.

A service life test that was performed under specific aggravated conditions (with the V-ribbed belt being subjected to dust and small stones) and temperature loadings yielded a threefold lengthening of service life, specifically from approximately 100 hours in the case of conventional V-ribbed belts from the prior art to approximately 300 hours in the case of the V-ribbed belt according to the invention.

The invention will be explained in greater detail on the basis of an exemplary embodiment. In the drawings:

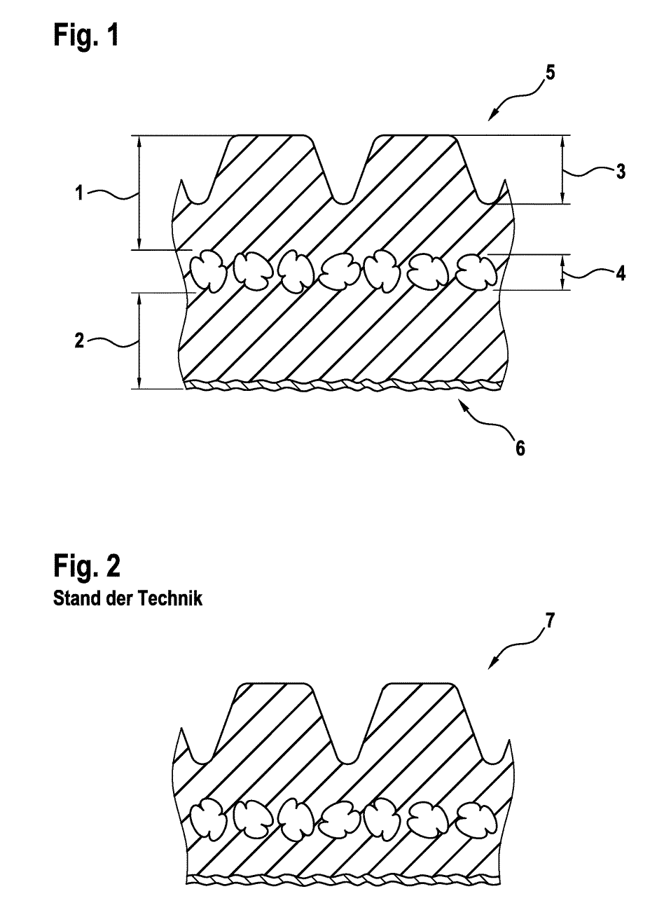

FIG. 1 shows the cross section of a V-ribbed belt according to the invention; and,

FIG. 2 shows the cross section of a V-ribbed belt from the prior art.

FIG. 1 shows the cross section of a V-ribbed belt 5 according to the invention composed of elastomer material with a flattened V-shaped profile on the drive side and with a substantially smooth rear side 6 situated opposite the drive side. Proceeding from the drive side, the belt has a substructure 1 which encloses the V-ribbed profile 3, and a layer of embedded tensile members/cords 4 and a top layer 2. The top layer 2 of the V-ribbed belt 5 illustrated here has a thickness of 2.1 mm. To realize the top layer thickness of 2.1 mm in the product, a mixture sheet of 2.3 mm was used in the manufacture of the unprocessed coil. A part of the mixture flows, in the vulcanization process, into the intermediate spaces between the cords. The top layer thickness 3 is therefore always smaller than the mixture sheet used in the manufacturing process. The profile depth of the V-ribbed profile 3 amounts to 1.8 mm. The top layer 2 is formed without fibers.

Above and/or below the embedded tensile members 4, the V-ribbed belt 5 shown here has a fiber-containing embedding mixture which is formed with a thickness of 0.5 mm. Said embedding mixture is however not illustrated in greater detail in the cross-sectional sketch shown here. In the embedding mixture which is situated in contact with the tensile members/cords 4 or cord layer with a thickness of 0.5 mm, the aramid fibers used here are oriented substantially in the belt circumferential direction, that is to say perpendicular to the plane of the drawing in FIG. 1.

FIG. 2 shows, on the same scale in relation thereto, the cross section of a V-ribbed belt 7 from the prior art, in the case of which the top layer is of thin form in accordance with the conventional teaching. Said thickness amounts in this case to approximately 0.7 mm. Both belts have a PK profile, that is to say a belt profile characterized by a flank angle of approximately 40° and a pitch of approximately 3.56 mm.

### LIST OF REFERENCE SIGNS

### (Part of the Description)

1 Substructure of the V-ribbed belt
2 Top layer
3 Flattened V-shaped profile
4 Tensile members/tensile member layer
5 V-ribbed belt, according to the invention
6 Substantially smooth rear side
7 V-ribbed belt, prior art

1.-8. (canceled)

9. A V-ribbed belt composed of elastomer material, the V-ribbed belt comprising:
a profiled drive side designed for the transmission of force to complementarily shaped belt pulleys; and,
a rear side disposed opposite the drive side and which is substantially smooth;
wherein the V-ribbed belt comprises, proceeding from the profiled drive side, a substructure with a ribbed profile formed as a PK profile in accordance with DIN 7867, a layer of embedded tensile members, and a top layer; and,
wherein the top layer of the V-ribbed belt has a thickness of greater than 1.5 mm, wherein the top layer is formed substantially without fibers, and wherein elastomer material of the substructure and of the top layer comprises ethylene propylene rubber.

10. The V-ribbed belt as claimed in claim 9, wherein profile depth of the ribbed profile is 2.1 mm or less.

11. The V-ribbed belt as claimed in claim 9, wherein thickness of the top layer is 3 mm or less.

12. The V-ribbed belt as claimed in claim 9, wherein the top layer has a thickness of from 1.8 to 3 mm.

13. The V-ribbed belt as claimed in claim 12, wherein the top layer has a thickness of 2.0 to 2.5 mm.

14. The V-ribbed belt as claimed in claim 9, wherein profile depth of the ribbed profile is from 1.5 to 1.9 mm.

15. The V-ribbed belt as claimed in claim 9, wherein in the layer of embedded tensile members the V-ribbed belt comprises a fibers containing embedding mixture having a thickness of 1 mm or less.

16. The V-ribbed belt as claimed in claim 15, wherein the fibers of the embedding mixture are oriented substantially in the belt circumferential direction.

17. The V-ribbed belt as claimed in claim 15, which in the region of the embedded tensile members has a fiber-containing embedding mixture which is formed with a thickness of less than 0.6 mm.

18. The V-ribbed belt as claimed in claim 15, wherein the fibers of the embedding mixture comprise aramid fibers, PVA fibers or a mixture thereof.

19. A V-ribbed belt composed of elastomer material, the V-ribbed belt comprising:
a profiled drive side designed for the transmission of force to complementarily shaped belt pulleys; and,
a rear side disposed opposite the drive side and which is substantially smooth;
wherein the V-ribbed belt comprises, proceeding from the profiled drive side, a substructure with a ribbed profile formed as a PK profile in accordance with DIN 7867, a layer of embedded tensile members, and a top layer; and,
wherein the top layer of the V-ribbed belt has a thickness of greater than 1.5 mm, wherein the top layer is formed substantially without fibers, and the elastomer material of the substructure and of the top layer comprises ethylene propylene diene rubber.

20. The V-ribbed belt as claimed in claim 19, wherein profile depth of the ribbed profile is 2.1 mm or less.

21. The V-ribbed belt as claimed in claim 19, wherein thickness of the top layer is 3 mm or less.

22. The V-ribbed belt as claimed in claim 19, wherein the top layer has a thickness of from 1.8 to 3 mm.

23. The V-ribbed belt as claimed in claim 22, wherein the top layer has a thickness of 2.0 to 2.5 mm.

24. The V-ribbed belt as claimed in claim 19, wherein profile depth of the ribbed profile is from 1.5 to 1.9 mm.

25. The V-ribbed belt as claimed in claim 19, wherein in the layer of embedded tensile members the V-ribbed belt comprises a fibers containing embedding mixture having a thickness of 1 mm or less.

26. The V-ribbed belt as claimed in claim 25, wherein the fibers of the embedding mixture are oriented substantially in the belt circumferential direction.

27. The V-ribbed belt as claimed in claim 25, which in the region of the embedded tensile members has a fiber-containing embedding mixture which is formed with a thickness of less than 0.6 mm.

28. The V-ribbed belt as claimed in claim 25, wherein the fibers of the embedding mixture comprise aramid fibers, PVA fibers or a mixture thereof.

29. A V-ribbed belt composed of elastomer material, the V-ribbed belt comprising:
a profiled drive side designed for the transmission of force to complementarily shaped belt pulleys; and,
a rear side disposed opposite the drive side and which is substantially smooth;
wherein the V-ribbed belt comprises, proceeding from the profiled drive side, a substructure with a ribbed profile formed as a PK profile in accordance with DIN 7867, a layer of embedded tensile members, and a top layer; and,
wherein the top layer of the V-ribbed belt has a thickness of greater than 1.5 mm, wherein the top layer is formed substantially without fibers, and the elastomer material of the substructure and of the top layer comprises ethylene propylene rubber and ethylene propylene diene rubber.
